(19) United States
(12) Patent Application Publication
(10) Pub. No.: US 2024/0382911 A1
(43) Pub. Date: Nov. 21, 2024

(54) VORTEX GAS-LIQUID APPARATUS

(71) Applicant: Victor N. Gurin, Henrico, VA (US)

(72) Inventors: Victor N. Gurin, Henrico, VA (US); Volodymyr Tonya, Hilton, NY (US); Serguei Permiakov, Kanata (CA); Petr V. Mazur, Broadway, VA (US)

(73) Assignee: Victor N. Gurin, Henrico, VA (US)

(21) Appl. No.: 18/692,321

(22) PCT Filed: Apr. 10, 2023
(86) PCT No.: PCT/US2023/018077

§ 371 Date: Mar. 14, 2024

Related U.S. Application Data
(60) Provisional application No. 63/370,511, filed on Aug. 5, 2022.

(51) Int. Cl. B01F 23/232; B01F 21/20; B01F 25/10; B01F 101/00

(52) U.S. Cl. CPC B01F 23/232; B01F 21/20; B01F 25/10; B01F 2101/501; B01F 2101/503; B01F 2215/0422

(57) ABSTRACT

The present invention claims a vortex gas-liquid apparatus for dissolving a gas or combination of gases in liquid to obtain a gas-liquid solution. The gas-liquid solution is obtained in a mixing chamber in the center of which a flow swirler is arranged to activate stirring and improve gas absorption by the liquid. The most effective use of the apparatus seems to be for dissolving hydrogen in petroleum products, such as gasoline or diesel fuel, and transporting them through main pipelines under pressure. Transportation of hydrogen in a state of solution in petroleum fuel will eliminate diffusion losses through the pipe walls or measuring devices along the pipeline.

### CROSS-REFERENCE TO RELATED APPLICATION

This application claims priority to U.S. Provisional Application No. 63/370,511 filed Aug. 5, 2022, content of which is incorporated herein by reference thereto.

### BACKGROUND OF THE INVENTION

Methods and means for dissolving gases in liquids (particularly in liquid fuels for injection into an engine's combustion chamber) are known in the prior art. One method of dissolving gas at high pressure into a thin film of fuel is described in U.S. Pat. No. 7,011,048 dated Mar. 14, 2006. Another method to disperse the smallest possible droplets of liquid fuel by using nozzles in high pressure gas medium is described in Russian Pat. 2,129,662 dated Feb. 2, 1998, U.S. Pat. No. 7,261,094 dated Aug. 28, 2007, U.S. Pat. No. 7,406,955 dated Aug. 5, 2008, U.S. Pat. No. 7,523,747 dated Apr. 28, 2009, and U.S. Pat. No. 8,037,849 dated Oct. 18, 2011. U.S. Pat. No. 6,273,072, dated Aug. 14, 2001, discloses methods of using both nozzles and a thin film of fuel.

The apparatuses claimed by all prior art patents require special vessels used for dissolving gas in liquid. In order to perform tasks as prescribed in prior art patents, said vessels function as a fluid-containing tank in which gas-liquid solution is accumulating during gas saturation. The volume of accumulating gas-liquid solution is measured by level sensors installed within the vessel tank. Hence, volume of accumulating gas-liquid solution is limited by the prescribed application of level sensors. In case of using gas saturation for fuels in the field of internal combustion engines, in order to satisfy engines' fuel demand, the prior art patents cause the necessity of increasing the vessel sizes, e.g., for a 500 hp engine the vessel of 2.5 gallons is required, and locating the vessels in vertical mounting position, hence limiting the applicability to particular machinery types. Size and positioning of the prior art tank vessels cause critical disadvantages, especially when engines operate at maximum loads. In addition, vessels of a large volume increase the cost of the system as a whole.

### SUMMARY OF THE INVENTION

In summary, the objective of the present invention is to solve the shortcomings of the prior arts patents by providing this invention is a system for gasification of liquids, in particular crude oils and petroleum fuels.

It is well known that vortex technologies can significantly reduce volumetric requirements, increasing specific efficiency.

This invention describes a vortex gas-liquid apparatus for gasification of liquids, comprising a body having a multi-nozzle head (1) for receiving gases and liquid though separate ports and central and peripheral nozzles that provide 1-st stage mixing of gases and liquid in a receiving chamber; the receiving chamber is an inlet port to a mixing chamber where a 2-d stage mixing is taking place; in the mixing chamber a stationary swirler which is a core-faring with several helical passages along its body; at the outlet, the mixing chamber is joined to a diffuser.

The liquid used in the gas absorption process may be gasoline, diesel fuel, aviation fuel, marine diesel oil, marine heavy fuel oil, or cruel oil; and the gas to be dissolved in the liquid fuel may be an air, oxygen, hydrogen, carbon dioxide, combustion exhaust, or natural gas, or mixtures thereof.

In addition to fuels and automotive industry the present invention may be used in chemical and petrochemical processes, medical devices, water purification, metallurgy, and other applicable areas where saturating gas into liquids is wanted.

The following detailed description illustrates the invention by way of example and not by way of limitation. This description will clearly enable one skilled in the art to make and use the invention, and describes several embodiments, adaptations, variations, alternatives, and uses of the invention, including what we presently believe is the best mode of carrying out the invention. As various changes could be made in the above constructions without departing from the scope of the invention, it is intended that all matter contained in the above description or shown in the accompanying drawings shall be interpreted as illustrative and not in a limiting sense.

### BRIEF DESCRIPTION OF DRAWINGS

FIG. 1 is the cross-sectional view of a proposed vortex gas-liquid apparatus according to the present invention.

FIG. 2 is a general view of a swirler according to the present invention.

### DETAIL DESCRIPTION OF THE INVENTION

The new technical solution is intended to reduce the mass and dimensions characteristics of the fuel solution preparation system for diesel and gasoline engines and other applications as well.

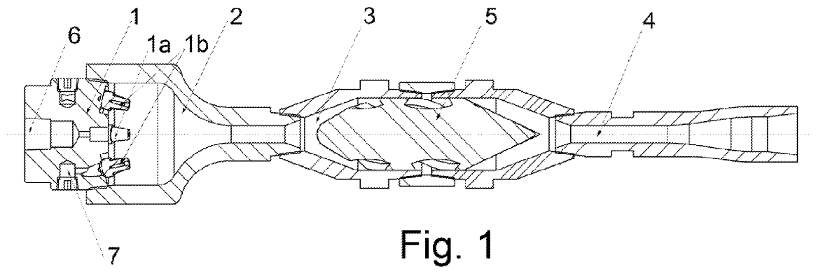

Referring to FIG. 1 the new vortex gas-liquid apparatus comprises the multi-nozzle head (1) with a central nozzle (1a) aligned along the central line of the apparatus body, and a group of peripheral nozzles (1b) arranged at an angle of up to 12 degrees with respect to the central nozzle (1a). The multi-nozzle head (1) is located in the receiving chamber (2) of the apparatus. The receiving chamber (2) is the inlet portion of the mixing chamber (3). The mixing chamber (3) is a cylindrical tube, located along the same axis as the central nozzle (1a). At least one stationary swirler (5) is installed inside the mixing chamber (3), which is a core-fairing with several helical channels formed on it. At the outlet, the mixing chamber (3) is joined to a diffuser (4), the degree of opening angle of which is 8 to 12 degrees.

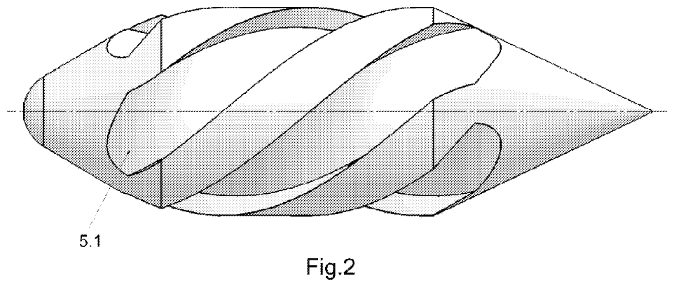

Referring to FIG. 2 the impeller (5) is designed to create an anti-separation effect, the reverse effect of Ranque-Hilsch. It has several helical channels (5.1) formed on the swirler (5) body.

A liquid is delivered to the central nozzle (1a) though an inlet port (6) under such pressure that provides for even and fine dispersion of the liquid droplets, e.g., of up to 45 bars.

Gas is delivered though an inlet port (7) to the peripheral nozzles (1a) under the pressure of no less than 100 bars. In some embodiments according to the present invention there may be separate inlet ports to each of peripheral nozzles or they connect a pair of peripheral nozzles to deliver different gases in the process.

Ejected liquid and gas streams are mixed in the receiving chamber (2) forming a gas-liquid flow which further directed to the swirler (5), where active mixing and crushing of gas bubbles take place, forming large contact surfaces of two phases and, accordingly, the process of gas dissolution in the liquid is activated.

In other embodiments depending on liquid viscosity or gas used in the mixing chamber (3) can be installed one or two additional swirlers with channels that change the direction of flows to promote the gas dissolution. If for the first swirler the channels involute clockwise, then the next one would have channels run anticlockwise and so on.

To increase the pressure of gas-liquid solution the diffuser (4) having an open angle of 8 to 12 degrees is provided.

There's growing consensus that hydrogen will be an important energy carrier in a transformed energy system. The proposed apparatus can be used in technological processes where it is required to mix hydrogen and liquid to obtain a solution. The most effective use of the apparatus seems to be for dissolving hydrogen in petroleum products, such as gasoline or diesel fuel, and transporting them through main pipelines under pressure. Transportation of hydrogen in a state of solution in petroleum fuel will eliminate diffusion losses through the pipe walls or measuring devices along the pipeline.

Studies have shown an abnormally high solubility of natural gas and hydrogen in petroleum fuels, for example, even at least 10-12 bar of pressure, the solubility coefficient per unit volume of fuel is 40-48.

At the final section of the pipeline, it is easy to separate the gas from the solution in its pure form by reducing the pressure. The proposed design is also convenient for pumping pressure along the length of the line. A distinctive feature of the vortex gas-liquid apparatus in comparison with any pumps is the absence of zones that contribute to a decrease in flow pressure.

1. A vortex gas-liquid apparatus for dissolution of gas into liquid, consisting of:
a. a multi-nozzle head having a central nozzle and a group of peripheral nozzles located at an angle of up to 12 degrees;
b. a receiving chamber where a liquid and a gas or group of gases are supplied to;
c. a mixing chamber for dissolution gases into liquid to provide gas-liquid solution;
d. a stationary swirler having a group of helical passages to promote gas dissolution in liquid;
e. a diffuser.

2. The apparatus according to claim 1, wherein the liquid is fed though the central nozzle and the gas or combination of gases is fed though the peripheral nozzles.

3. The apparatus according to claim 1, wherein the liquid or combination of liquid is fed through peripheral nozzles and gas is fed through the central nozzle.

4. The apparatus according to claim 1 further containing at least one additional swirler having a group of channels that run anticlockwise to the ones of the first swirler.

5. The apparatus according to claim 1, wherein the liquid is fed though the central nozzle and one of gasoline, diesel fuel, aviation fuel, marine diesel oil, marine heavy fuel oil, biodiesel, crude oil, or mixtures thereof.

6. The apparatus according to claim 1, wherein the gas to be dissolved in the liquid is fed though peripheral nozzles and one of air, oxygen, hydrogen, carbon dioxide, combustion exhaust, natural gas, or mixtures thereof.
